(19) United States
(12) Patent Application Publication
(10) Pub. No.: US 2009/0304515 A1
(43) Pub. Date: Dec. 10, 2009

(54) METHOD AND DEVICE FOR JOINING BY WAY OF INDUCTIVE HF PRESSURE WELDING A ROTOR BLADE WITH A ROTOR SUPPORT OF A GAS TURBINE WITH AUTOMATIC SUPPLY OF THE ROTOR BLADE

(75) Inventors: Herbert Hanrieder, Hohenkammer (DE); Alexander Gindorf, Schwabhausen (DE); Reinhold Meier, Dorfen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/293,540

(22) PCT Filed: Mar. 14, 2007
(86) PCT No.: PCT/DE2007/000457

§ 371 Date: Jun. 5, 2009

(30) Foreign Application Priority Data
Mar. 20, 2006 (DE) 10 2006 012 675.0

(51) Int. Cl. F01D 5/30; B23K 13/01; B23P 15/04; B23Q 7/02

(52) U.S. Cl. 416/213 R; 219/617; 29/23.51

(57) ABSTRACT

A method and a device for joining at least one rotor blade or at least one part of a rotor blade with a rotor support of a gas turbine, in particular a rotor blade connection of the rotor support, is disclosed. Corresponding connecting surfaces of the rotor blade, the rotor blade part, the rotor support or the rotor blade connection of the rotor support are joined by inductive high-frequency pressure welding. In this case, at least one rotor blade or rotor blade part is automatically supplied from at least one rotor blade reservoir and/or rotor blade part reservoir and, in addition, the rotor support is automatically positioned in such a way that the connecting surfaces to be joined are positioned precisely with respect to one another for the joining process.

This application claims the priority of International Application No. PCT/DE2007/000457, filed Mar. 14, 2007, and German Patent Document No. 10 2006 012 675.0, filed Mar. 20, 2006, the disclosures of which are expressly incorporated by reference herein.

### BACKGROUND AND SUMMARY OF THE INVENTION

The present invention relates to a method for joining at least one rotor blade or at least one part of a rotor blade with a rotor support of a gas turbine, in particular a rotor blade connection of the rotor support, wherein corresponding connecting surfaces of the rotor blade, the rotor blade part, the rotor support or the rotor blade connection of the rotor support are joined by inductive high-frequency pressure welding. The invention also relates to a device for joining at least one rotor blade or at least one part of a rotor blade with a rotor support of a gas turbine, in particular a rotor blade connection of the rotor support, wherein corresponding connecting surfaces of the rotor blade, the rotor blade part, the rotor support or the rotor blade connection of the rotor support are joined by inductive high-frequency pressure welding.

Various methods and devices for connecting metallic structural elements by means of inductive high-frequency pressure welding are known from the prior art. Thus, German Patent Document No. DE 198 58 702 A1 describes a method for connecting blade parts of a gas turbine, wherein a blade pan section and at least one other blade part are made available. In this case, corresponding connecting surfaces of these elements are essentially positioned, aligned and spaced apart from one another, and then welded to one another by exciting an inductor with high-frequency current, and by moving them together with their connecting surfaces making contact. In this process, the inductor is excited with a constant frequency, which generally lies above 0.75 MHz. In addition, the frequency is selected as a function of the geometry of the connecting surfaces. In the case of inductive high-frequency pressure welding, simultaneously and homogenously heating the two welding mates is of crucial importance for the quality of the joint. What is disadvantageous in the known methods and devices, however, is that mass production with correspondingly high production rates is not possible in this case.

As a result, it is the objective of the present invention to make available a generic method for joining at least one rotor blade or at least one part of a rotor blade with a rotor support of a gas turbine, which guarantees, on the one hand, a secure and lasting connection of the gas turbine elements and high production rates on the other.

It is further the objective of the present invention to make available a generic device, which guarantees, on the one hand, a secure and lasting connection of the gas turbine elements and high production rates, on the other.

For clarification purposes, it is expressly mentioned at this point that the designation inductive high-frequency pressure welding does not define the method or the device in the case at hand at a specific frequency range. In fact, frequencies in the low kHz range up to the high MHz range are used so that the new designation inductive pressure welding (IPW) could also be adopted.

An inventive method for joining at least one rotor blade or at least one part of a rotor blade with a rotor support of a gas turbine, in particular a rotor blade connection of the rotor support, wherein corresponding connecting surfaces of the rotor blade, the rotor blade part, the rotor support or the rotor blade connection of the rotor support are joined by inductive high-frequency pressure welding of the rotor support, is comprised of the automatic supply of at least one rotor blade or rotor blade part from at least one rotor blade reservoir and/or rotor blade part reservoir and an automatic positioning of the rotor support in such a way that the connecting surfaces to be joined are positioned precisely with respect to one another for the joining process. High production rates are guaranteed by making rotor blades or rotor blade parts available in a corresponding reservoir, for example, a magazine device. In addition, the use of the inductive high-frequency pressure welding assures a secure and lasting connection between the rotor blade or the rotor blade part and the rotor support or the rotor blade connection of the rotor support.

The high production rates are also guaranteed by the automatic positioning of the rotor support, because the automatic positioning has a positive effect on the quality of the resulting workpiece. Only in exceptional cases does the manufacture of defective products occur.

In this case, for automatic positioning, a rotary table can be provided to accommodate the rotor support, wherein the rotary table is rotated around a defined angle dimension. The angle dimension conforms to the number of rotor blades to be applied or the corresponding number rotor blade connections formed on the rotor support. In an advantageous embodiment of the inventive method, the rotary table can be mounted on a longitudinally displaceable axis so that not only a rotational movement but also a longitudinal movement of the positioning device and thus of the rotor support is possible.

In another advantageous embodiment of the inventive method, the rotor blade or rotor blade part is conveyed to a clamping device, wherein the connecting surface of the rotor blade or of the rotor blade part is moved and pressed against the connecting surface of the rotor support or of the rotor blade connection of the rotor support by means of the clamping device. On the one hand, the clamping device guarantees that the rotor blade or the rotor blade part is moved in the correct position on the rotor support. In addition, the clamping device applies the required compression force on the rotor blade or the rotor blade part without the latter being subjected to excessive compressive load.

In another advantageous embodiment of the inventive method, before and during moving the rotor blade or the rotor blade part against the rotor support or the rotor blade connection of the rotor support, a position and location check of the rotor blade or of the rotor blade part and/or of the rotor support or of the rotor blade connection of the rotor support is carried out. This results in a precise positioning of the joining mates for joining the blades on the rotor support in a manner that is close to the final contour. The position and location check can be carried out in this case by an optical measuring instrument. In addition, it is possible for position and location checks to be carried out.

In another advantageous embodiment of the inventive method, the rotor blade or rotor blade part is surrounded at least partially by a holding device. In doing so, the rotor blade or rotor blade part can be cast integrally in the holding device or be insert molded with it. Because of the holding device, congruent positioning of the rotor blade or rotor blade part and rotor support or rotor blade connection of the rotor support is also guaranteed. In addition, an inflexible and rigid guidance of the rotor blade is produced during the movement and pressing process of joining. In particular, positioning precision is yielded in the case of rotor blades with at least partially three-dimensionally formed flanks. Due to the positioning precision, post-processing costs in the welding area are reduced in particular. The holding device in this case can be made of a dissolving material, in particular polystyrene. By using this type of material, the production rate is increased further, because an additional work step to remove the holding device is not necessary. Depending upon the selection of material, the dissolution of the holding device can be accomplished by an increase in temperature.

In another advantageous embodiment of the inventive method, an inductor is fastened in or on the holding device. This makes it possible to guarantee a precise and aligned position of the inductor relative to the connecting surfaces of the element being joined. Additional work steps, which include positioning the inductor, are not necessary, which contribute to a further increase in production rates along with increasing the quality of the joint.

In another advantageous embodiment of the inventive method, a base-like element for holding and guiding the rotor blade or the rotor blade part during and after the process of inductive high-frequency pressure welding is formed on the end of the rotor blade or of the rotor blade part that is opposite from the connecting surface. Through the embodiment of this type of base-like element, it is possible to advantageously support all processing procedures on the rotor blade. Thus, the base-like element is used, for example, to hold the rotor blade during the milling of the melt projections after joining the rotor blade with the rotor blade connection of the rotor support.

An inventive device for joining at least one rotor blade or at least one part of a rotor blade with a rotor support of a gas turbine, in particular a rotor blade connection of the rotor support, wherein corresponding connecting surfaces of the rotor blade, the rotor blade part, the rotor support or the rotor blade connection of the rotor support are joined by inductive high-frequency pressure welding, features at least a supply device for automatically supplying at least one rotor blade or rotor blade part from at least one rotor blade reservoir and/or rotor blade part reservoir and a positioning device for automatically positioning the rotor support, wherein the connecting surfaces to be joined are positioned precisely with respect to one another for the joining process by means of the positioning device. Making rotor blades or parts of rotor blades available in a corresponding reservoir and the supply device guarantee an automatic production flow. The precise positioning of the rotor support relative to the rotor blade or to the part of the rotor blade also results in high production rates, because it is possible to automate this process as a whole. In doing so, the positioning device can be a rotary table for accommodating the rotor support, wherein the rotary table can be rotated around a defined angle dimension. The angle dimension in this case conforms to the number of rotor blade connections on the rotor support. In addition, the rotary table can be mounted on a longitudinally displaceable axis so that a longitudinal displacement is also possible along with a rotation of the rotor support.

In an advantageous embodiment of the inventive device, the device has at least one clamping device, wherein the rotor blade or the rotor blade part is conveyed to the clamping device and the connecting surface of the rotor blade or of the rotor blade part can be moved and pressed against the connecting surface of the rotor support or of the rotor blade connection of the rotor support by means of the clamping device. The required compressive force is advantageously applied via the clamping device on the rotor blade or rotor blade part without producing an excessive compressive load on these parts.

In another advantageous embodiment of the inventive device, the device has a position and location check device for the position and location check of the rotor blade or of the rotor blade part and/or of the rotor support or of the rotor blade connection of the rotor support before and during moving the rotor blade or the rotor blade part against the rotor support or the rotor blade connection of the rotor support. This guarantees precise joining of the rotor blade or of the rotor blade part with the rotor support or the rotor blade connection. In addition, it is possible for position and location checks to be carried out. The position and location check device in this case can be an optical measuring instrument. Integrated position measurement of the involved structural elements in connection with controlling corresponding drive devices permits a precise positioning of the joining mates for joining the blades on the rotor support in a manner that is close to the final contour. A gear-free linear motor and an absolute value rotary encoder can be used in this case.

In another advantageous embodiment of the inventive device, the rotor blade or rotor blade part is at least partially surrounded by a holding device. In this case, the rotor blade or rotor blade part can be cast integrally in the holding device or be insert molded with it. This type of holding device guarantees precise and congruent positioning of the rotor blade or rotor blade part with the corresponding rotor blade connection of the rotor support. In addition, an inflexible and rigid guidance of the rotor blade during the movement and pressing process of joining is guaranteed. According to one embodiment, the holding device is made of a dissolvable material, in particular polystyrene. The use of such a material advantageously guarantees that an additional processing step is not required for removing the holding device from the rotor blade or the rotor blade part.

In another advantageous embodiment of the inventive device, an inductor is fastened in or on the holding device. The result of this is a precise and aligned position of the inductor with the welding area, i.e., in particular, with the connecting surfaces of the to-be-welded structural elements of the gas turbine.

In another advantageous embodiment of the invention, a base-like element for holding and guiding the rotor blade or the rotor blade part during and after the process of inductive high-frequency pressure welding is formed on the end of the rotor blade or of the rotor blade part that is opposite from the connecting surface. This sort of embodiment of a base-like element makes it possible to support all processing procedures on the rotor blade. In particular, this base is used for holding purposes during milling of the melt projections after the corresponding joining of the cited structural elements.

An inventive component is manufactured in accordance with the methods described in the forgoing. These components are so-called BLINGs (bladed ring) or BLISKs (bladed disc) of gas turbine engines.

### BRIEF DESCRIPTION OF THE DRAWINGS

Additional advantages, features and details of the invention are disclosed in the following description of two graphically depicted exemplary embodiments. The drawings show:

FIG. 1 is a schematic representation of an inventive device according to a first embodiment; and

FIG. 2 is a schematic representation of an inventive device according to a second embodiment

### DETAILED DESCRIPTION OF THE DRAWINGS

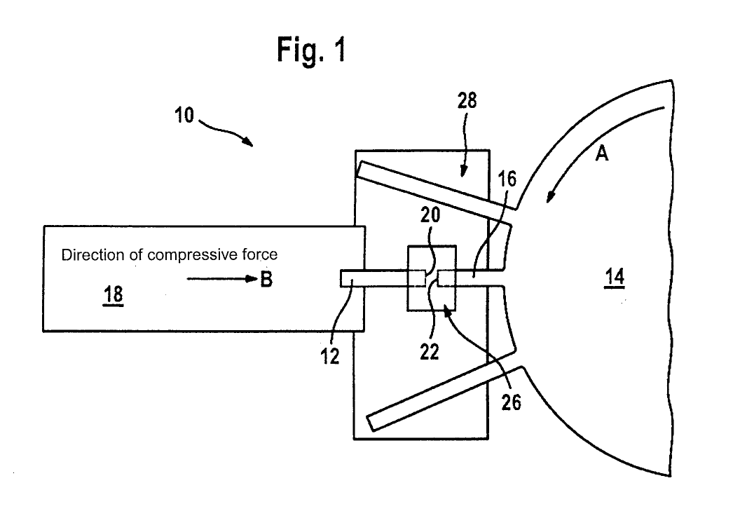

FIG. 1 depicts a first embodiment of a device 10 for joining at least one rotor blade 12 with a rotor support 14 of a gas turbine, namely a rotor blade connection 16 of the rotor support 14, wherein corresponding connecting surfaces 20, 22 of the rotor blade 12 and of the rotor blade connection 16 are joined by inductive high-frequency pressure welding. The device 10 in this case is comprised of a generator 28 for generating the required welding energy and an inductor 26. Connecting surfaces 20, 22 of the blade 12 and of the rotor blade connection 16 are heated by exciting the inductor 26 with high-frequency current. The heating occurs in this case up to at least near the respective melting point of the materials from which the blades 12 and the rotor blade connection 16 are manufactured. In the depicted embodiment, the rotor blade connection 16 is embodied on the circumference of a disk. The disk in this case represents a so-called BLISK rotor.

In addition, one can see that a clamping device 18 presses the rotor blade 12 in arrow direction B against the rotor blade connection 16. Moving the rotor blade 12 towards the rotor blade connection 16 is accomplished in this case with sufficiently great heating of the connecting surfaces 20, 22. This is then the case if the connecting surfaces 20, 22 are almost molten and have reached a doughy state.

The rotor support 14 in the depicted exemplary embodiment is mounted on a rotary table (not shown). The rotary table and thus the rotor support 14 can be rotated in arrow direction A around a defined angle dimension. This results in a precise positioning of the rotor blade connection 16 with respect to the rotor blade 12 or a precise positioning of the corresponding connecting surfaces 20, 22 to one another. In addition, the perpendicular arrangement of the rotor blade 12 in the device 10 provides accessibility of the weld location with an induction coil arranged on the rear for small and large cross sections. Normally, the welding area is in a protective gas atmosphere, which is either generated locally or can comprise the entire welding area.

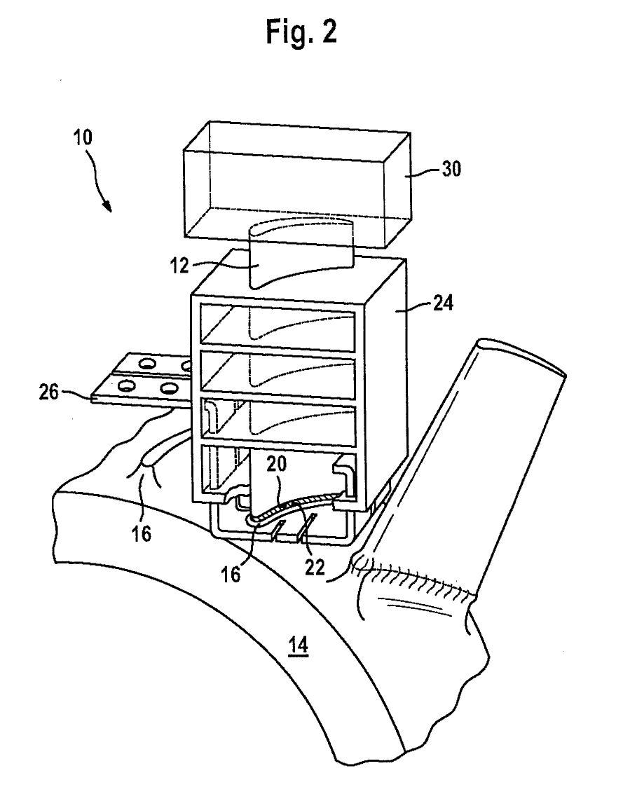

FIG. 2 shows a second embodiment of a device 10 for joining a rotor blade 12 with a rotor blade connection 16 of the rotor support 14. In this exemplary embodiment, one can see that the rotor blade 12 is surrounded by a holding device 24. In this case, the rotor blade 12 can be cast integrally in the holding device 24 or be insert molded with it. In the depicted exemplary embodiment, the holding device 24 is made of polystyrene. In addition, one can see that an inductor 26 is fastened on the holding device 24. This results in a precise positioning of the inductor in the area of the connecting surfaces 20, 22 when joining the blades 12 with the rotor blade connection 16.

In addition, one can see that a base-like element 30 for holding and guiding the rotor blade 12 during and after the process of inductive high-frequency pressure welding is formed on the end of the rotor blade 12 or of the rotor blade part that is opposite from the connecting surface 20.

The devices 10 in accordance with the exemplary embodiments depicted in FIGS. 1 and 2 also comprise a supply device for automatically supplying the rotor blades 12 from a rotor blade reservoir.

In this case, the rotor blade 12, rotor blade parts or rotor support 14 can be made of different or similar metallic materials. However, it is also possible for the cited structural elements to be made of similar metallic materials and be manufactured by different manufacturing methods. This relates for example to forged structural elements, structural elements produced by casting methods, structural elements comprised of single crystals as well as directionally solidified structural elements.

The exemplary embodiment makes it clear that the inventive method as well as the device 10 are suited both for manufacturing as well as repairing components of a gas turbine.

1-23. (canceled)

24. A method for joining at least one rotor blade or at least one part of a rotor blade with a rotor support or a rotor blade connection of the rotor support of a gas turbine, wherein corresponding connecting surfaces of the rotor blade, the rotor blade part, the rotor support or the rotor blade connection of the rotor support are joined by inductive high-frequency pressure welding, wherein the at least one rotor blade or rotor blade part is automatically supplied from at least one rotor blade reservoir and/or rotor blade part reservoir and wherein, in addition, the rotor support is automatically positioned in such a way that the connecting surfaces to be joined are positioned precisely with respect to one another for the joining process.

25. The method according to claim 24, wherein to automatically position the rotor support, a rotary table is provided to accommodate the rotor support and the rotary table is rotated around a defined angle dimension.

26. The method according to claim 25, wherein the rotary table is mounted on a longitudinally displaceable axis.

27. The method according to claim 24, wherein the rotor blade or the rotor blade part is conveyed to a clamping device, wherein the connecting surface of the rotor blade or of the rotor blade part is moved and pressed against the connecting surface of the rotor support or of the rotor blade connection of the rotor support by the clamping device.

28. The method according to claim 24, wherein before and during moving the rotor blade or the rotor blade part against the rotor support or the rotor blade connection of the rotor support, a position and location check of the rotor blade or of the rotor blade part and/or of the rotor support or of the rotor blade connection of the rotor support is performed.

29. The method according to claim 28, wherein the position and location check is performed by an optical measuring instrument.

30. The method according to claim 24, wherein the rotor blade or rotor blade part is surrounded at least partially by a holding device.

31. The method according to claim 30, wherein the rotor blade or rotor blade part is cast integrally in the holding device or is insert molded with the holding device.

32. The method according to claim 30, wherein the holding device is made of a dissolvable material.

33. The method according to claim 30, wherein an inductor is fastened in or on the holding device.

34. The method according to claim 24, wherein a base-like element for holding and guiding the rotor blade or the rotor blade part during and after the inductive high-frequency pressure welding is formed on an end of the rotor blade or of the rotor blade part that is opposite from the connecting surface.

35. A device for joining at least one rotor blade or at least one part of a rotor blade with a rotor support or a rotor blade connection of the rotor support of a gas turbine, wherein corresponding connecting surfaces of the rotor blade, the rotor blade part, the rotor support or the rotor blade connection of the rotor support are joined by inductive high-frequency pressure welding, comprising at least one supply device for automatically supplying at least one rotor blade or rotor blade part from at least one rotor blade reservoir and/or rotor blade part reservoir and a positioning device for automatically positioning the rotor support, wherein the connecting surfaces to be joined are positioned precisely with respect to one another for the joining process by the positioning device.

36. The device according to claim 35, wherein the positioning device is a rotary table for accommodating the rotor support and is rotatable around a defined angle dimension.

37. The device according to claim 36, wherein the rotary table is mounted on a longitudinally displaceable axis.

38. The device according to claim 35, further comprising at least one clamping device, wherein the rotor blade or the rotor blade part is conveyed to the clamping device and the connecting surface of the rotor blade or of the rotor blade part is movable and pressed against the connecting surface of the rotor support or of the rotor blade connection of the rotor support by the clamping device.

39. The device according to claim 35, further comprising at least one position and location check device for a position and location check of the rotor blade or of the rotor blade part and/or of the rotor support or of the rotor blade connection of the rotor support before and during moving the rotor blade or the rotor blade part against the rotor support or the rotor blade connection of the rotor support.

40. The device according to claim 39, wherein the position and location check device is an optical measuring instrument.

41. The device according to claims 35, wherein the rotor blade or rotor blade part is surrounded at least partially by a holding device.

42. The device according to claim 41, wherein the rotor blade or rotor blade part is cast integrally in the holding device or is insert molded with the holding device.

43. The device according to claim 41, wherein the holding device is made of a dissolvable material.

44. The device according to claim 41, wherein an inductor is fastened in or on the holding device.

45. The device according to claim 35, further comprising a base-like element for holding and guiding the rotor blade or the rotor blade part during and after the inductive high-frequency pressure welding, wherein the base-like element is formed on an end of the rotor blade or of the rotor blade part that is opposite from the connecting surface.

46. A component manufactured in accordance with a method according to claim 24, wherein the component is a BLING or BLISK.
